(19) United States
(12) Patent Application Publication
(10) Pub. No.: US 2011/0073602 A1
(43) Pub. Date: Mar. 31, 2011

(54) Lightweight cookware and method of making same

(75) Inventors: David Charles Musil, Cumming, GA (US); Nina C. Frazier, Mableton, GA (US)

(73) Assignee: Calphalon Corporation, Atlanta, GA (US)

(21) Appl. No.: 12/893,771

(22) Filed: Sep. 29, 2010

Related U.S. Application Data
(60) Provisional application No. 61/246,666, filed on Sep. 29, 2009.

(51) Int. Cl. A47J 27/00; B32B 7/02; B05D 1/02; B22D 19/08; B05D 5/08

(52) U.S. Cl. 220/573.2; 220/573.1; 156/242; 427/427; 164/100; 427/209

(57) ABSTRACT

A light weight cookware article has a foam core with exposed exterior surfaces. The foam core is formed of a carbon foam material and has a barrier layer on the exterior surfaces of the foam core. The cookware article has an upper facing food contacting side and a downward facing heat source side opposite the food contacting side. A method of making the article includes fabricating a foam core vessel from the carbon foam material and applying the barrier layer on the exposed surface of the foam core vessel covering the food contacting side and the heat source side

### RELATED APPLICATION DATA

This patent is related to and claims priority benefit of U.S. provisional patent application Ser. No. 61/246,666 entitled “Lightweight Performance Cookware” filed on Sep. 29, 2009. The entire contents of this prior filed provisional application are hereby incorporated by reference herein.

### BACKGROUND

1. Field of the Disclosure

The present invention generally relates to cookware and cooking vessels, and more particularly to lightweight cookware and methods of making such cookware.

2. Description of Related Art

Conventional cookware articles typically include a cooking vessel or plate and a handle to manipulate and carry the vessel or plate. Premium or high quality cookware of this type typically includes the vessel portion being made of a high grade metal material. Such metals are thermally conductive and often include iron, aluminum, titanium, and/or steel. Typical high performance cookware has superior performance characteristics such as durability, thermal conductivity, cleanability, non-stick, appearance, and the like. However, such high performance or high quality cookware tends to be fairly heavy. During use, such cookware can also hold or contain a large quantity of food being cooked. The combination of the weight of the cookware and food can result in the cookware article being substantially heavy and cumbersome, even for the most experienced and fit cook. Difficulty in manipulating a heavy cookware article containing food can result in the food being spilled or dumped from the vessel or plate. Such difficulty may even result in accidental burns by unintended or inadvertent contact between the heated vessel and the cook's skin.

Attempts have been made to reduce the weight of cookware articles. One such method is to reduce the amount of material, and hence the thickness of the cooking vessel walls. These attempts result in the cookware looking and feeling inexpensive or cheap. These attempts have also resulted in the cookware providing decreased performance characteristics including reduced durability and heat retention.

### SUMMARY

In one example according to the teachings of the present invention, a cookware article has a foam core with exposed exterior surfaces and can be formed of a carbon foam material. A barrier layer is provided on the exterior surfaces of the foam core. The cookware article has an upper facing food contacting side and a downward facing heat source side opposite the food contacting side.

In one example, at least part of the barrier layer can be formed of aluminum.

In one example, the foam core can be a graphite foam material.

In one example, at least part of the barrier layer can be a sprayed metal material.

In one example, at least part of the barrier layer can be a sprayed aluminum layer.

In one example, the barrier layer can be comprised of two formed metal sheets.

In one example, the barrier layer can be comprised of two formed metal sheets that can be brazed to the exterior surfaces of the foam core.

In one example, the cookware article can include a vessel with a central section and a side wall surrounding the perimeter of the central section; and a handle extending outward from a part of the side wall.

In one example, the foam core also has a central section and a side wall that define the shape of a vessel.

In one example, the cookware article can include a treated layer on an outer surface of the barrier layer.

In one example, the barrier layer can be metal with an outer surface that can be anodized.

In one example, a non-stick coating can be provided on a treated layer of the food contacting side of the cookware article.

In one example, a non-stick coating can be provided on an outermost surface of the food contacting side of the cookware article.

In one example according to the teachings of the present invention, a method of making a light weight cookware article includes fabricating a foam core vessel from a carbon foam material. The foam core vessel has an exterior exposed surface with an upward facing food contacting side and a downward facing heat source side. A barrier layer is applied on the exposed surface of the foam core vessel covering the food contacting side and the heat source side.

In one example, the step of applying can include adhering a metal layer on the exposed surface of the foam core.

In one example, the step of applying can include spraying a metal layer on the exposed surface of the foam core.

In one example, the step of applying can include spraying an aluminum layer on the exposed surface of the foam core.

In one example, the step of applying can include die casting a metal layer around the foam core.

In one example, the method can include applying or creating a treated layer on an outer surface of at least part of the barrier layer and can include adhering a non-stick coating to the treated layer.

In one example, the step of applying can include applying the same material on both the food contacting side and the heat source side of the foam core vessel.

In one example, the step of fabricating can include fabricating the foam core vessel from a graphite foam material.

### BRIEF DESCRIPTION OF THE DRAWINGS

Objects, features, and advantages of the present invention will become apparent upon reading the following description in conjunction with the drawing figures, in which:

FIG. 1 shows a perspective view of one example of a cookware article in the form of a skillet constructed in accordance with the teachings of the present invention.

FIG. 2 shows a cut-away section of the skillet shown in FIG. 1.

FIG. 3 shows a perspective view of another example of a cookware article in the form of a griddle constructed in accordance with the teachings of the present invention.

FIG. 4 shows a cut-away section of the griddle in FIG. 3.

FIG. 5 shows a foam core substrate after being formed or shaped in the configuration of the vessel of the skillet in FIG. 1.

FIG. 6 shows a block of foam core substrate material that can be used to form the skillet foam core in FIG. 5.

FIG. 7 shows a cut-away section of the foam core substrate in FIG. 5.

FIG. 8 shows the foam core substrate in FIG. 7 after a barrier layer has been applied or deposited onto the foam core material.

FIG. 9 shows the foam core substrate and barrier layers in FIG. 8 after surfaces of the barrier layer have been anodized or otherwise treated.

FIG. 10 shows the anodized or treated cookware vessel in FIG. 9 after a non-stick layer of material has been added to surfaces of the vessel.

FIG. 11 shows an alternate example of a foam core substrate similar to that depicted in FIG. 7, but having a brazing compound added to exposed surfaces of the foam core material.

FIG. 12 shows the foam core substrate and brazing compound in FIG. 11 after two metal sheets have been brazed onto the foam core substrate and shaped to minor a cooking vessel configuration.

### DETAILED DESCRIPTION OF THE DISCLOSURE

Cookware articles or products are disclosed herein that solve or improve upon one or more of the above-identified and/or other problems and disadvantages with prior known cookware. In one example, the disclosed cookware includes a vessel and a handle for carrying the vessel. The vessel is a lightweight configuration providing a high quality appearance and high performance characteristics. In one example, the vessel includes an inner core of a thermally conductive foam material surrounded by a thermally conductive barrier layer. In one example, the barrier layer can be a metal that has been sprayed onto the core of foam material. In another example, the barrier layer can be brazed onto the foam core. In one example, the barrier layer can be a die cast metal layer around the foam core. In one example, the foam core material can be provided as a block of material and machined or otherwise shaped to define a cookware vessel. The disclosed cookware results in a premium or high quality product that is very lightweight in comparison to prior known high performance cookware. However, the disclosed cookware can be created to provide the appearance of a thick, high quality or high performance cookware product having high performance characteristics.

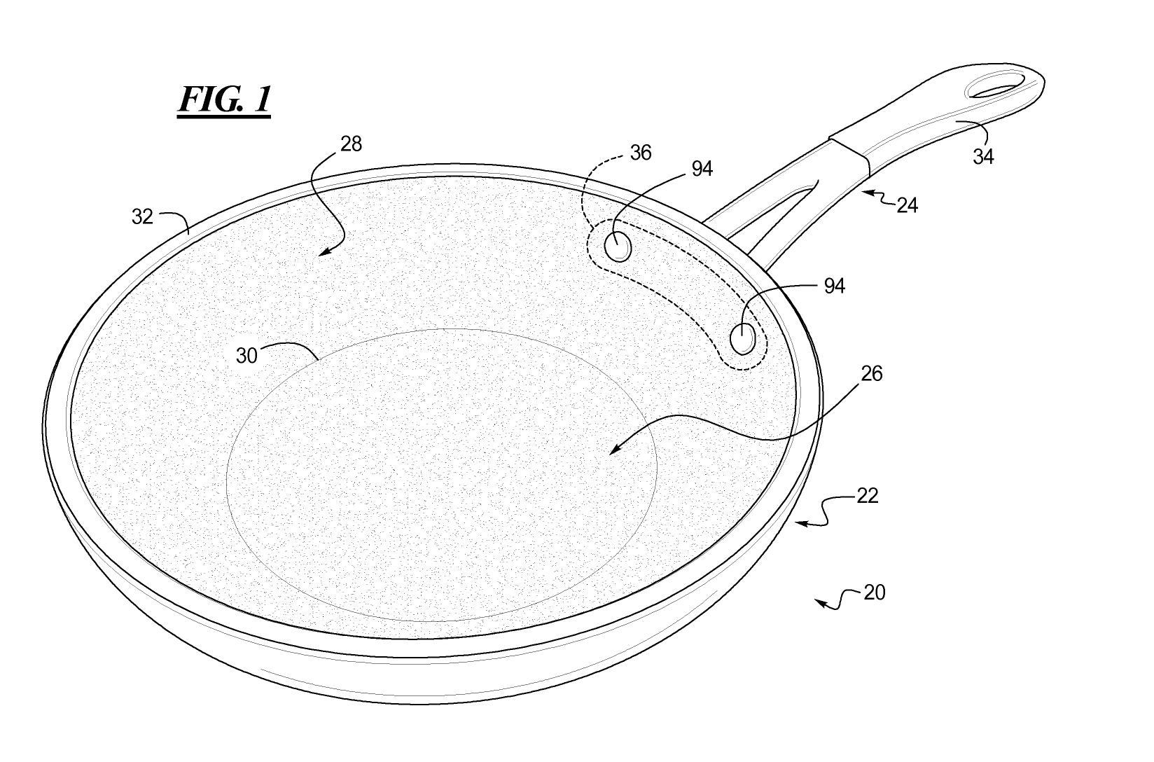

Turning now to the drawings, FIG. 1 shows one example of a cookware article or product in the form of a skillet 20 constructed in accordance with the teachings of the present invention. In this example, the skillet 20 has a cooking portion or vessel 22 and a handle 24 extending from the vessel. In this example, the vessel 22 has a circular configuration with a generally planar central section 26 and a side wall 28 extending up from a perimeter 30 of the central section. The side wall gradually curves outward and upward from the perimeter 30 and terminates at a top edge 32. The top edge 32 defines an opening or open top of the vessel 22 exposing the central section 26 for cooking.

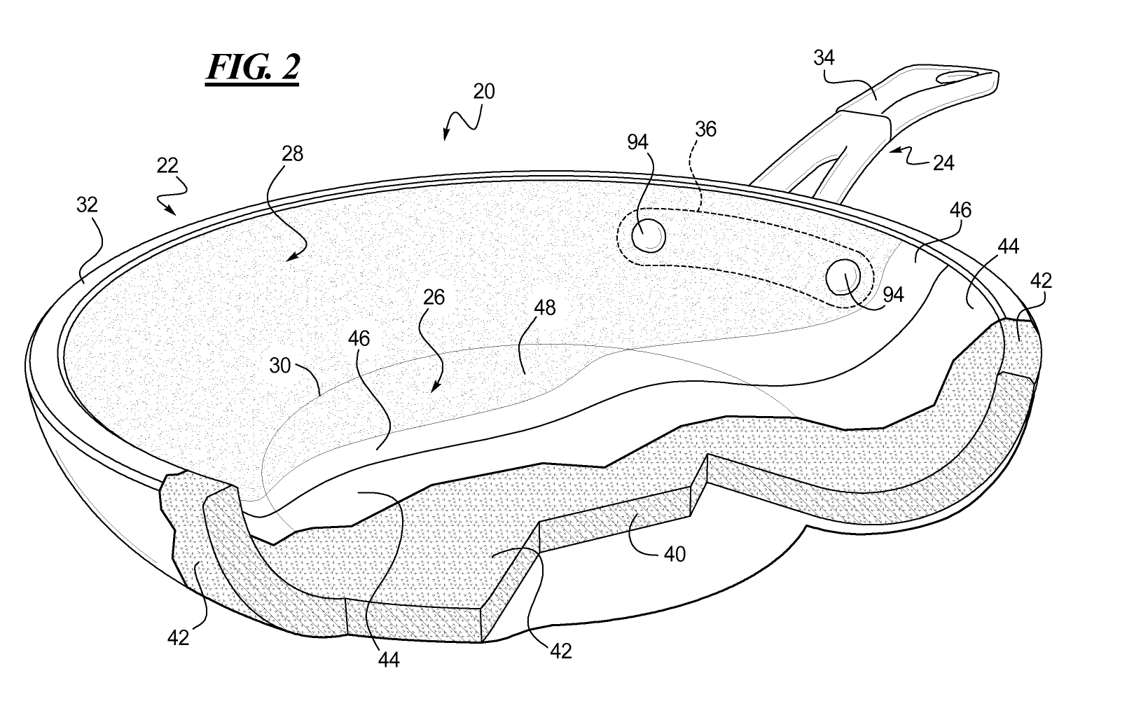

In this example, the handle 24 has an elongate grip section 34 that extends from the side wall 28 normal to the vessel 22. The grip section 34 can be gripped or grasped by one hand of a user as is known in the art to hold and carry the skillet 20. The handle 24 also has a mounting section 36 (shown only in phantom in FIGS. 1 and 2) integrally formed at one end of the grip section 34. The mounting section 36 can be attached to the vessel 22 to connect the handle 24 to the vessel. The configuration and construction of the handle 24 can vary considerably within the spirit and scope of the present invention. The handle 24 can be cast, forged, or otherwise formed from one or more metal materials. In one example, the grip section 34 can include a temperature resistant overlay material that can be contoured to ergonomically adapt to conform to the shape of a hand, be textured to improve grip, and/or include additional overlay materials to enhance friction, making it easier for a user to grasp and hold the skillet 20. The metal or other base material of the handle 24 can also vary and can include aluminum, iron, steel, powdered metal, or the like. Alternatively, the handle 24 can be a non-metal material such as Nylon composite or other suitable materials, as discussed further below. The handle 24 can be configured to have reduced heat conductivity so that the handle can be gripped comfortably while cooking.

FIG. 2 shows a cross section of the vessel 22 of the skillet 20 in this example. The vessel 22 generally has a lightweight foam core 40 constructed of a material that has suitably high thermal conductivity and thermal diffusivity for cooking purposes. In one example, the foam core 40 can be fabricated from a carbon foam material, such as graphite foam, which typically has a weight of about ⅕ that of aluminum. Such graphite foam material that is particularly well suited for cookware usage in accordance with the teachings of the present invention is disclosed in, for example, U.S. Pat. Nos. 6,033,506 (Klett), 6,037,032 (Klett et al.), and 6,576,168 (Hardcastle et al.). In addition, such carbon and/or graphite foam materials are available commercially from Poco Graphite, Inc., of Decatur, Tex. under the name POCOFOAM and from Koppers, Inc., of Pittsburgh, Pa. under the name KFOAM. The foam material can differ from the examples disclosed herein as long as the material has characteristics rendering it capable of holding its shape, being relatively strong, and having good thermal conductivity and diffusivity suitable for distributing heat for cooking.

Carbon or graphite foam materials are relatively porous and thus would not be suitable on their own for forming cookware. Thus, as shown in FIG. 2, the foam core 40 generally has one or more additional layers of material applied to or disposed on exposed surfaces 42 of the core 40. In this example, at least a barrier layer 44 is provided directly against the exposed surfaces 42 of the foam core 40. The barrier layer 44 is provided, at least in part, to close the pores of the porous surfaces on the foam core 40. In one example, the barrier layer 44 can be a metal such as aluminum as described below.

The barrier layer 44 can be treated to create a protective coating or protective layer 46 on the exterior side of the barrier layer on the vessel 22. Alternatively, the protective layer 46 can be an additional material layer applied over the barrier layer 44, depending on the nature of the barrier layer material and its surface characteristics when applied. In one example, the exposed surface of metal barrier layer 44 can be anodized to create the treated layer 46, also discussed in greater detail below. As shown in FIG. 2, an optional non-stick coating 48 or surface treatment can be applied over or formed on at least a portion of the exposed surfaces of the vessel 22. In this example, the non-stick layer 48 is provided on or over part of the treated or anodized layer 46. Details and options for these and potentially other layers over the foam core 40 are discussed in greater detail below, as are a number of optional methods for manufacturing the vessel 22 inclusive of these additional layers.

As will become evident to those having ordinary skill in the art upon reading this disclosure, the configuration and contour of cookware articles, such as the skillet 20, including the vessel 22 and handle 24, can vary considerably within the spirit and scope of the present invention. The shape of the vessel can vary from the circular or round shape of the skillet 20. The side walls can be taller, shorter, more or less vertical, more or less rounded, linear, angled, and/or the like. The volume of the vessel can vary. The vessel can be provided as a plate structure with no discernable side walls, if desired. The plate structure can be flat, planar, grooved, or otherwise contoured.

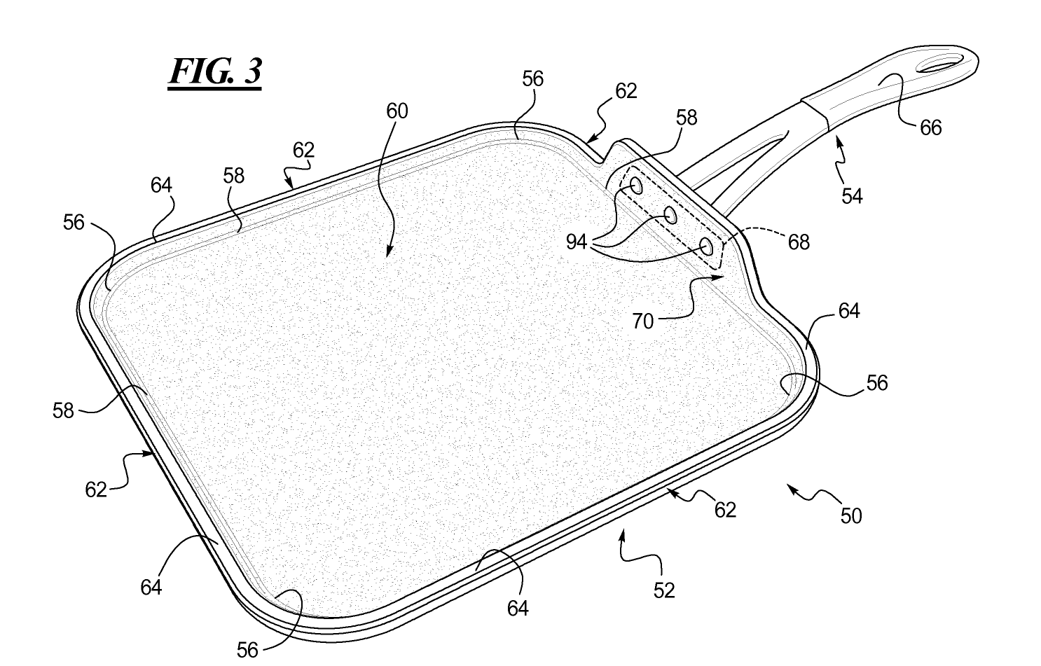

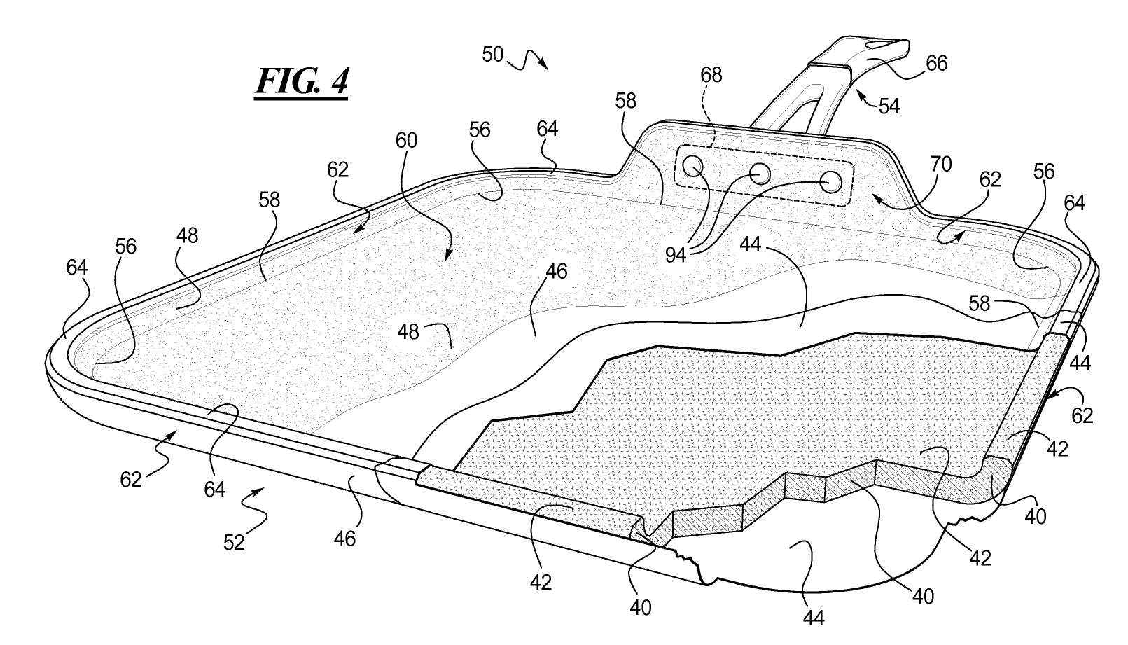

To illustrate, an alternative example of a cookware article is illustrated in FIGS. 3 and 4 in the form of a griddle 50. Similar to the prior example, the griddle 50 has a cooking portion or vessel 52 and a handle 54 extending perpendicularly from one side of the vessel. The vessel 52 in this example can have a generally rectangular or square configuration with rounded corners 56 and linear sides 58 between the corners. The vessel 52 has a substantially flat and square central section 60 and a short height side wall 62 extending up from the edges of the central section at each of the sides 58 and corners 56. In this example, the side walls 62 terminate at a top edge 64 that is not much above the elevation of the central section 60.

The griddle 50 in this example is representative of a conventional griddle configuration. However, the griddle 50 is manufactured with the same characteristics as the above-described skillet 20 and thus has a foam core 40, a barrier layer 44, a treated layer 46, and a non-stick layer 48 as depicted in FIG. 4. The handle 54 in this example also has an elongate grip section 66 connected at one end to a mounting section 68 (also shown only in phantom in FIGS. 3 and 4). The mounting section 68 in this example is essentially linear to coincide with the shape of the side wall 62 to which it is attached. In the prior example, the mounting section 36 on the handle 24 was curved to coincide with the contour of the curved side wall 28. As show in FIG. 3, one of the side walls 62 has a taller or raised mid-section 70. The mounting section 68 of the handle 54 is attached to this raised mid-section 70.

In each of the disclosed examples, the cookware article, i.e., the skillet 20 and the griddle 50, has a food contacting surface 80 on the exposed upward facing side of the respective central sections 26 and 60. Each of the cookware articles also has a heat source side 82 opposite the food contacting side 80 on the underside of the respective central sections 26 and 60. The heat source sides 82 are configured to bear against, contact, rest on, or be directly exposed to a heat source such as an electric or gas stove burner, an open flame, an iron grate, or the like.

Regardless of the shape and configuration of the cookware article, and particularly the vessel portion, the cookware will typically include a food contacting side and a heat source side as disclosed and described herein. However, as noted above the vessel need not have a side wall at all. Instead, the vessel can be provided in the form of a generally flat plate or a non-flat, contoured plate with no side wall. Alternatively, the height, shape, and configuration of the side wall can vary considerably for a particular cookware article in accordance with the teachings of the present invention. The side wall can be configured to receive a lid at or near the top edge of the side wall to close off the vessel and cover the food contacting side. Similarly, the cookware article can be provided with no handle at all or having two or more handles or grips. The shape and configuration of the handles can also vary from the examples shown and described herein. For example, two handles can be provided on opposite sides of a pot-like vessel. Each such handle can be of a conventional U-shape with two attachment points to the vessel and a transverse handle grip.

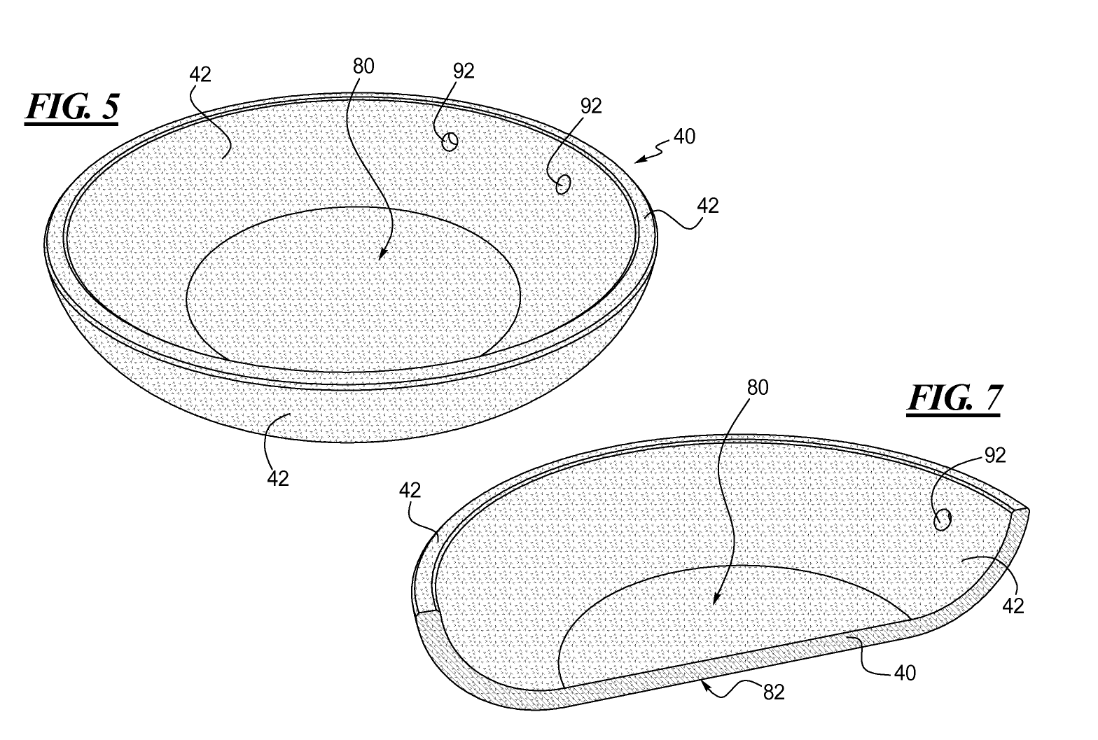

The various materials and methods or processes used to fabricate lightweight performance cookware in accordance with the teachings of the present invention are described herein with reference to the skillet 20 of the first embodiment described above. FIG. 5 shows the foam core 40 in perspective view without any of the additional material layers of the vessel 22. In this example, the foam core 40 essentially takes on and defines the overall final shape of the vessel 22. Such a shaped foam core 40 can be created from carbon foam, graphite foam, or other suitable lightweight materials using a number of different methods or processes to achieve the particular desired shape.

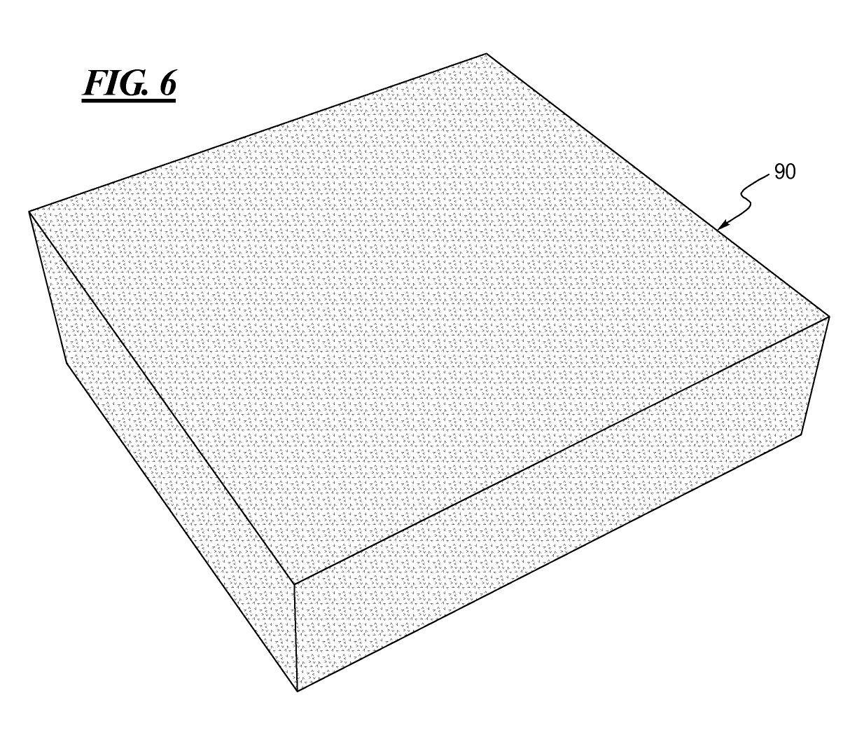

In one example, the crystalline structure of graphite foam described in the above-mentioned U.S. patents to Klett and Hardcastle can be grown into the shape of the foam core 40 depicted in FIG. 5. The crystalline structure can be grown using techniques that are known in the art or more suitable techniques may be developed in the future. In another example, a block substrate 90 of graphite foam material can be grown or provided as depicted in FIG. 6. The substrate 90 can then be cut, machined, drilled, and/or the like using known, conventional, or other methods to shape the foam material. Material can be removed from the block substrate 90 to achieve the foam core 40 shape depicted in FIG. 5. In yet another example, the base foam material can be molded when manufactured to achieve the desired vessel configuration, such as the skillet configuration depicted in FIG. 5. It is also possible that two or more such methods or processes be used to achieve the finished, desired foam core shape.

As noted above, the material of the foam core 40 can be a suitable carbon foam material such as those disclosed in the aforementioned patents to Klett and Hardcastle. In one example, the material can be a graphite foam material as mentioned above. However, the invention is not intended to be limited only to graphite foam, but instead can include other suitable lightweight, foam-like or other suitable materials. Such core materials should weigh significantly less than metal, such as aluminum typically used for cookware. Such core materials should also have thermal conductivity and diffusivity characteristics suitable for cooking. Such core materials should also have strength and durability characteristics capable of withstanding the rigors of cooking, at least after the cookware articles are completed with all material layers applied and finished.

With respect to the disclosed example, graphite foam is known to be relatively porous. The pores or spaces within the material can be filled with a liquid or a gas to enhance various properties of the material such as, for example, heat transfer, foam expansion, weight, and/or simply to eliminate air in the core. Such additive material should also be suitable to withstand the rigors of repeated heating and cooling from cooking after the cookware article is manufactured.

As shown in FIG. 5, a pair of holes 92 is formed through the side wall 28 of the skillet foam core 40. These holes 92 are used for attaching the handle 24 to the vessel 22 when assembled. Handle fasteners 94 such as threaded fasteners, rivets, or the like can be utilized to secure the handle 24 to the vessel, as is known in the art, once the vessel 22 fabrication is completed. Once the foam core 40 is formed to its desired shape and configuration, additional layers of material can be added to the core, as desired and as needed for a particular application to complete vessel fabrication.

In this example, the exposed surfaces 42 of the foam core 40 are also relatively porous, as the substrate material of the foam core 40 is porous. Thus, the foam core material standing alone would not be suitable for cooking. Contamination of the surfaces 42 would occur during use. For example, juices or other liquid resulting from food being cooked directly on the surfaces 42 would be absorbed into the foam core 40. The core would be difficult if not impossible to clean. Such contamination would also alter the heat transfer, diffusivity, and retention performance characteristics of the core material, and likely would significantly degrade such performance.

As a result, in the present example, the barrier layer 44 is added to the exposed surfaces 42 of the foam core 40. The materials and techniques used to create and apply the barrier layer 44 can vary within the spirit and scope of the present invention. In one preferred example, the barrier layer 44 is formed from a metal material applied to the exposed surfaces 42 to seal the porous material. In other examples, the barrier layer 44 can be a material such as a composite or ceramic material that is suitable to withstand exposure to high temperatures while still providing acceptable thermal conductivity and diffusivity as well as being relatively durable to withstand the rigors of cooking and cleaning.

In order to achieve good thermal conductivity and cooking performance, intimate contact between the exposed surfaces 42 of the foam core 40 and the barrier layer 44 is desired. The material used need only be cooking safe. In one preferred example, the barrier layer 44 is formed from a metal such as aluminum, stainless steel, titanium, and/or copper. One or more such materials can be applied to different portions or regions on the surfaces 42 of the foam core 40 to provide desired properties for the various surfaces of the cooking vessel 22.

In one preferred example, the barrier layer 44 is formed by spraying atomized metal, such as aluminum, onto the exposed surfaces 42. Metal spraying techniques are known in the art and can be utilized to apply a metal layer over the foam core. Metal spraying techniques are capable of applying a metal layer with a consistent thickness. Further, metal spraying techniques can be controlled to produce metal layers from extremely thin to quite thick. Use of a metal spraying technique can also be used to assure that the porous surface 42 of the foam core 40 is completely covered and sealed.

Though the thickness of the barrier layer 44 can vary, the barrier layer can be applied from a selected material having a thickness suitable to enhance the strength and durability of the foam core material. Minimizing the thickness of the barrier layer 44 may be desirable to minimize the weight of the cookware article and maximize heat transfer. However, the layer should be, at a minimum, thick enough to completely seal the porous structure of the foam core 40. The barrier layer 44 can also be applied so as to enhance the strength and durability of the finished cookware article. Graphite foam material is known to have adequate strength under compression, but may have tensile strength characteristics that are unsuitable for withstanding the rigors of cooking. Application of the barrier layer 44 in the form of a sprayed on metal, such as aluminum, can be performed to create a layer having a thickness sufficient to improve the tensile strength of the overall vessel 22, thus rendering the vessel 22 and its foam core 40 suitable for cooking. If the foam core 40 is provided from a less porous and/or a stronger material than the commercially available carbon foam products disclosed in this example, the thickness of the barrier layers 44 can be reduced, which may improve thermal conductivity and thus performance of the cookware during use.

In the disclosed example, the barrier layer is formed by spraying a layer of aluminum on the exposed surfaces 42 of the foam core 40. Aluminum is a highly suitable material for the barrier layer 44 in that it is lightweight, is durable, is thermally conductive, has suitably high tensile strength, and is commonly used for cookware. A number of metal spraying processes are known in the art. In one example, a plasma spray process can be utilized, which atomizes the metal base material to a very small droplet size. This can result in a fairly smooth, even, consistent barrier layer 44. Spraying metal droplets onto the foam core 40 ensures intimate contact with the surface 42 and sealing of the porous surface. In a plasma spray process, an electric arc burns within the nozzle of a plasma gun. Arc gas is formed into a plasma jet as it emerges from the nozzle of the plasma gun. Metal powder particles are injected into the jet to melt the particles. The particles then strike the surface of the foam core 40 at high velocity and adhere to the exposed surfaces 42. When cooled, the adhered particles form a metal layer on the foam core 40. Almost any material can be sprayed using such a plasma spraying process including metals, such as the preferred aluminum, as well as ceramics, and even plastic materials. The foam core 40 will remain relatively cool because the plasma is localized at the nozzle of the plasma gun.

In another example, an arc spray process can be utilized to spray the barrier layer material, such as aluminum, onto the exposed surfaces 42 of the core 40. In this type of process, raw aluminum materials are provided in the form of wires that are melted using an electric arc. The molten material is atomized using a jet of compressed air and propelled toward the surfaces 42 of the foam core 40. Alternatively, a flame spray process can be used whereby a single wire of aluminum or other raw material is melted in an oxygen fuel gas flame. The molten material is atomized by a cone of compressed air and again propelled toward the foam core 40. In another alternate example, a high velocity oxygen fuel (HVOF) process can be utilized to spray the barrier layer 44 over the exposed surfaces 42 on the foam core 40. In this process, liquid fuel and oxygen can be fed from a premixing system at high pressure into a combustion chamber. The liquid fuel and oxygen burn in the chamber to produce a hot, high pressure gas stream. The gas stream is expanded through a nozzle to increase the velocity of the gas exiting the nozzle. Powder or molten metal can be injected into the gas stream, atomizing the material, and then propelled toward the exposed surfaces 42 of the foam core 40.

In yet another example, the foam core 40 can be dipped in a liquid metal bath. Different parts of the foam core can be dipped into different liquid metals as desired to apply different barrier materials to various selected surfaces of the foam core 40. Additionally, the length of time the core is dipped can be altered for different portions of the foam core. For example, the generally horizontal heat source side 82 on the foam core 40 can be dipped for a longer period of time in a molten metal bath so that the porous foam material absorbs more of the metal and thus may become stronger and more thermally conductive. The side wall 28 of the foam core 40 can be dipped for a shorter period of time in order to take on less metal material. In still another example, the barrier layer 44 can be precision die cast over or around the foam core 40. The foam core 40 can be placed inside a die cast mold. A metal material, such as aluminum, can then be die cast around the foam material. The thickness of such a die cast layer can be from about 0.5 mm to about 2.5 mm or thicker, if desired.

Metal spraying offers an advantage suitable for the present invention. A metal spraying process allows one to control very precisely the thickness of the layer of metal applied to the foam core 40. Similar to the above-mentioned dipping process, metal spraying technology can allow for spraying different materials onto different surfaces of the foam core and/or different metal layer thicknesses onto different portions of the core. A thicker layer of metal can be applied to only those portions of the foam core that might require or benefit from a thicker layer of metal or barrier material. For example, as with the above-mentioned dipping method, the heat source side of the foam core can be formed having a thicker sprayed metal layer, if desired.

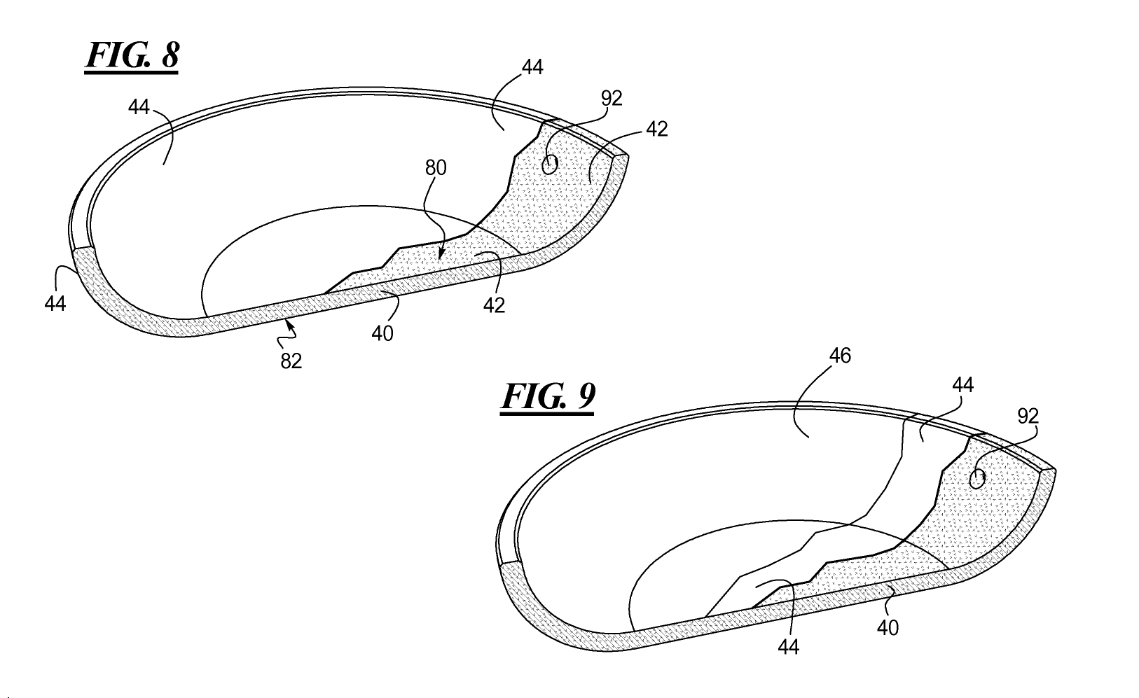

FIG. 8 shows the foam core 40 with the barrier layer 44 applied. In practice, the thickness of a metal sprayed barrier layer 44 can range anywhere between about 0.002 inches to about 0.250 inches, and particularly for aluminum. The foam core 40 can be formed having a thickness that is thin enough to provide good thermal conductivity and yet thick enough that the overall cookware article 20 is similar to or resembles standard, all metal, cookware, and particularly what is considered high quality or high performance cookware article. In one example, the foam core 40 can have a thickness of about 0.10 inches to about 0.50 inches. To resemble a number of existing high performance cookware products, the foam core can be provided having a thickness of between about 0.18 inches to about 0.30 inches. In one example, the barrier layer 44 of sprayed aluminum can be provided as thin as 0.020 inches for a useful metal layer. However, during testing, such a thin barrier layer was shown to be almost too thin in that it did not lie flat when applied. In a preferred example, an aluminum sprayed barrier layer 44 can be provided having a thickness of about 0.040 to 0.045 inches.

The overall thickness of a conventional high performance aluminum cookware article is typically about 0.188 inches thick in most portions of the vessel. Using the lightweight cookware and methods disclosed herein, a high performance cookware article such as the skillet 20 can be produced having a thickness of about 0.27 to 0.28 inches, even thicker than the conventional high performance product. This can result in the cookware, such as the skillet 20, having an appearance that is similar or identical to a conventional high performance cookware article. However, the skillet 20 can have a final assembled weight of about ⅓ that of the conventional aluminum article. Cookware articles as disclosed herein can be formed weighing as little as 0.5 pounds up to about 2.5 pounds and most can be formed having a weight between about 0.75 pounds to about 1.5 pounds. The overall wall thickness of the cookware articles disclosed and described herein can be as little as 0.012 inches to about 0.75 inches and in one example can be between about 0.30 inches to about 0.40 inches. In the disclosed examples, the ratio of the overall wall thickness of the cooking vessel to the weight of the cookware can be about 0.2 to about 0.5 and in a preferred range of about 0.24 to about 0.4. The invention allows for a high performance cookware article to be produced with a significantly lower thickness to weight ratio while being as thick as or even thicker than a conventional high performance cookware article.

Additional layers can be added, applied, or created over the barrier layer 44. In one example, a stainless steel layer can be sprayed over the aluminum layer to provide a different appearance, different strength and durability characteristics, or the like. In another example, the outer surface of the barrier layer 44 of aluminum can be hard anodized forming an anodized layer or treated layer 46 on the barrier layer 44. For example, if the barrier layer 44 is aluminum, the exposed surface of the aluminum can be hard anodized, which increases the thickness of the natural oxidized layer at the surface. This results in increased surface hardness. The hardened or treated layer 46 thus will have increased corrosion and wear resistance in comparison to the underlying aluminum base material. The anodized or treated layer 46 of aluminum will also allow the surface to be dyed or colored, if desired, and can improve adhesion if another layer is added. FIG. 9 shows the foam core 40 and sprayed metal vessel 22 depicted in FIG. 8 after the aluminum surface of the barrier layer has been anodized.

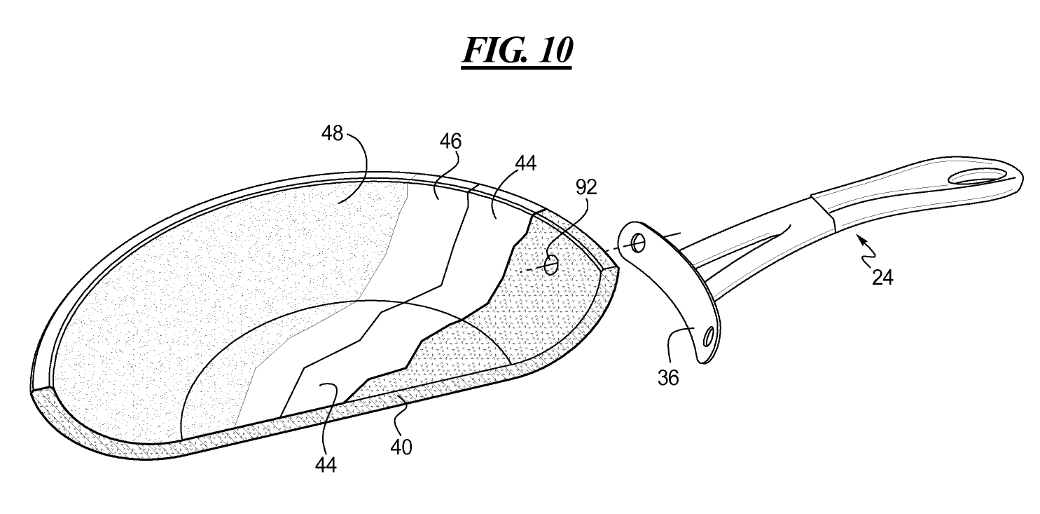

In another alternative example, the surface of the barrier layer 44 can be nitrided to create non-stick properties directly on the barrier layer. In a further example, a non-stick layer 48 can be applied to the barrier layer 44 or, in this example, the anodized or otherwise treated layer 46. A typical non-stick material layer 48 can be provided in the form of a baked enamel coating, a porcelain coating, or a single or multi-layer coatings using a fluoropolymer formulation, of which polytetrafluoroethylene is the standard active ingredient. These types of coatings are known in the art and can be applied in a conventional manner. FIG. 10 shows the anodized vessel in FIG. 9 after a layer 48 of non-stick material has been applied to the food contacting side 80 of the central section 26 and the interior surfaces 84 of the side walls 28. The complete handle 24 is also shown in FIG. 10, including the grip section 32 and mounting section 34.

As will become evident to those having ordinary skill in the art upon reading this disclosure, the composition, number, and application of the various layers of material over the foam core 40 can vary within the spirit and scope of the present invention. An exposed copper layer can be provided on the heat source side 82 of the central section 26 if desired. The remaining surfaces of the vessel can have an exposed material other than copper, such as aluminum or stainless steel. Such a construction can provide specific performance characteristics and mimic the appearance of some high performance or high end cookware.

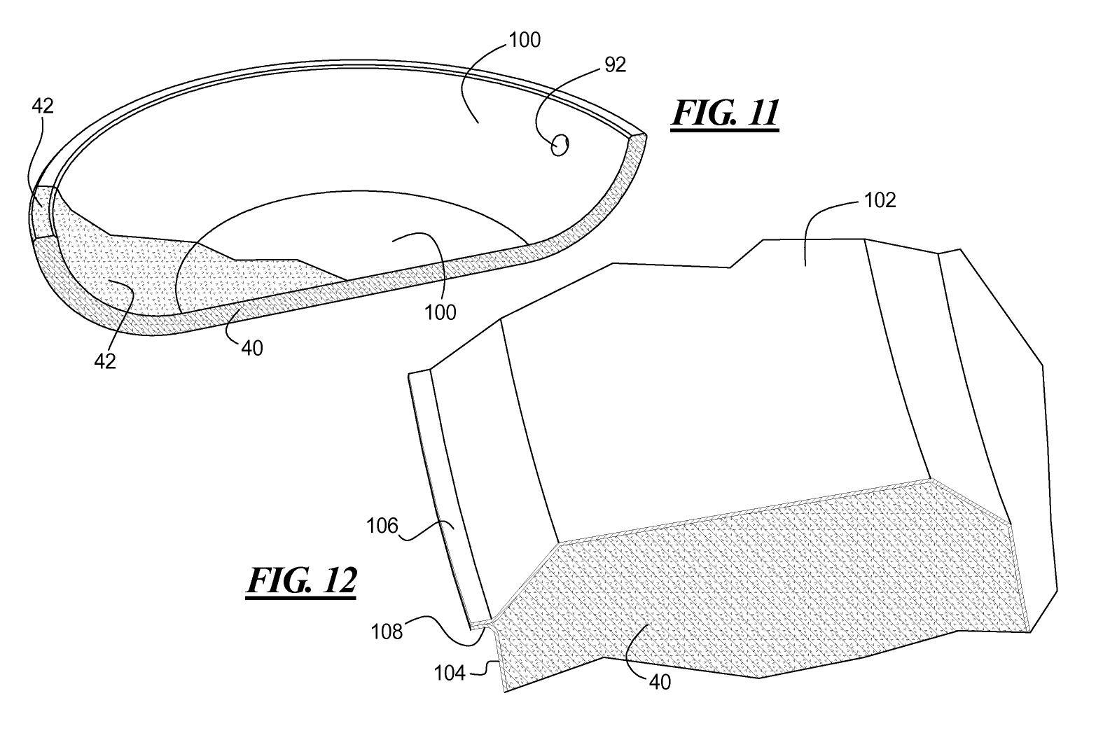

The barrier layer 44 can be applied or adhered to the foam core using methods and processes other than the metal spraying or metal bath processes noted above. FIGS. 11 and 12 depict one alternate example of a cookware article formed using a different process. As shown in FIG. 11, the foam core 40 can be created and formed to mimic the shape of a cooking vessel, such as the skillet vessel 22 of FIG. 5. A brazing compound 100 can be applied to the exposes surface 42 of the core 40. Examples of suitable brazing compounds include aluminum/zinc alloy (such as a 50%-50% allow of aluminum and zinc) or an aluminum/silicon composition (such as a 78%-12% composition of aluminum and silicon).

As shown in FIG. 12, two metal sheets 102 and 104 can be formed to create bottom and outside portion (sheet 102) of the barrier layer and the top and inside portion (sheet 106) of the barrier layer. As noted above, intimate contact between the foam core 40 and the barrier layer 44 is desired. In this example, the brazing compound should be applied so as to leave very few or virtually no air pockets between the metal sheets 102 and 104 and the core when brazed using applied heat. Also, the metal sheets should be formed to very closely match the shape and contour of the foam core so as to avoid lack of intimate contact. The metal sheets can be pre-formed using molding, stamping, pressing, and/or other suitable techniques. The pre-formed sheets can then be brazed to the foam core 40. A substantially continuous bond will be created between the foam core 40 and the sheets 102, 104 by the brazing compound 100.

The free edges 106, 108 of the two metal sheets 102, 104, respectively, extend beyond the top edge 32 of the vessel side wall 28. These free edges 106, 108 can then be bent, rolled, pressed, or otherwise abutted to one another and can then welded or otherwise joined together. The joined exposed edges 106, 108 can then be machined or otherwise worked to finish the edge of the vessel.

As noted above, the handles 24, 54 can also vary in material and construction. In one alternative example, the handle can be fabricated from a similar foam core, light weight construction. However, it is preferable that the handle be made of a material with poor thermal conductivity. The POCOFOAM or KFOAM carbon foam materials can be used. However, an engineered plastic material such as GRAVI-TECHT™ from GLS Corporation can be used for all or part of the handle construction. The connection between the handles and cookware vessels described herein can be of a conventional nature or can be modified to account for or accommodate the foam core 40 material, if desired.

Each and every layer disclosed and described herein can be further treated, polished, sanded, blasted, painted, colored, died, textured, and/or the like. Such additional processes can be used to create a specific appearance for the final cookware article. Such processes can also be used on sub-layers so that subsequently applied layers adhere better or perform better during use. For example, the barrier layer can be treated to smooth the surface and decrease surface roughness before applying additional layers or treating or anodizing its surface.

Although certain cookware articles or products and methods of making same have been described herein in accordance with the teachings of the present disclosure, the scope of coverage of this patent is not limited thereto. On the contrary, this patent covers all embodiments of the teachings of the disclosure that fairly fall within the scope of permissible equivalents.

What is claimed is:

1. A cookware article comprising:
a foam core having exposed exterior surfaces and formed of a carbon foam material; and
a barrier layer on the exterior surfaces of the foam core,
wherein the cookware article has an upper facing food contacting side and a downward facing heat source side opposite the food contacting side.

2. A cookware article according to claim 1, wherein at least part of the barrier layer is aluminum.

3. A cookware article according to claim 1, wherein the carbon foam material is graphite foam.

4. A cookware article according to claim 1, wherein at least part of the barrier layer is a sprayed metal material.

5. A cookware article according to claim 4, wherein the sprayed metal material is aluminum.

6. A cookware article according to claim 1, wherein the barrier layer is comprised of two metal sheets.

7. A cookware article according to claim 6, wherein the two metal sheets are brazed to the exterior surfaces of the foam core.

8. A cookware article according to claim 1, further comprising:
a vessel with a central section and a side wall surrounding the perimeter of the central section; and
a handle extending outward from a part of the side wall.

9. A cookware article according to claim 8, wherein the foam core also has a central section and a side wall that define the shape of the vessel.

10. A cookware article according to claim 1, further comprising a treated layer on an outer surface of the barrier layer.

11. A cookware article according to claim 10, wherein the barrier layer is metal and the outer surface is anodized to create the treated layer.

12. A cookware article according to claim 10, further comprising a non-stick coating on the treated layer of the food contacting side of the cookware article.

13. A cookware article according to claim 1, further comprising a non-stick coating on an outermost surface of the food contacting side of the cookware article.

14. A method of making a light weight cookware article, the method comprising the steps of:
fabricating a foam core vessel from a carbon foam material, the foam core vessel having an exterior exposed surface with an upward facing food contacting side and a downward facing heat source side; and
applying a barrier layer on the exposed surface of the foam core vessel covering the food contacting side and the heat source side.

15. A method according to claim 14, wherein the step of applying includes adhering a metal layer on the exposed surface of the foam core.

16. A method according to claim 14, wherein the step of applying includes spraying a metal layer on the exposed surface of the foam core.

17. A method according to claim 14, wherein the step of applying includes spraying an aluminum layer on the exposed surface of the foam core.

18. A method according to claim 14, wherein the step of applying includes die casting a metal layer around the foam core.

19. A method according to claim 14, further comprising the steps of:
applying or creating a treated layer on an outer surface of at least part of the barrier layer; and
adhering a non-stick coating to the treated layer.

20. A method according to claim 14, wherein the step of applying includes applying the same material on both the food contacting side and the heat source side of the foam core vessel.

21. A method according to claim 14, wherein the step of fabricating includes fabricating the foam core vessel from a graphite foam material.
